(19) United States
(12) Patent Application Publication
(10) Pub. No.: US 2014/0336978 A1
(43) Pub. Date: Nov. 13, 2014

(54) MOVING BODY PLACEMENT DETERMINING METHOD, MEASURING APPARATUS, MACHINING APPARATUS, AND STORAGE MEDIUM

(71) Applicant: CANON KABUSHIKI KAISHA, Tokyo (JP)

(72) Inventors: Yutaka NIWAYAMA, Kawasaki-shi (JP); Hiroyuki YUKI, Utsunomiya-shi (JP)

(73) Assignee: CANON KABUSHIKI KAISHA, Tokyo (JP)

(21) Appl. No.: 14/269,695

(22) Filed: May 5, 2014

(30) Foreign Application Priority Data
May 13, 2013 (JP) 2013-101283

(51) Int. Cl. G01B 21/16

(52) U.S. Cl. CPC G01B 21/16
USPC 702/150

(57) ABSTRACT

Provided is a method for determining a placement of a moving body that moves to face an object and perform a process at a plurality of target points on the object. The method includes the following steps executed by a processor: a step of setting candidates regarding the placement of the moving body for each of the plurality of target points; a step of obtaining a processable area, which is capable of being processed by the moving body in the object, corresponding to each of the set candidates; and a step of determining the candidate corresponding to a combination of the processable areas as the placement of the moving body by obtaining the combination of the processable areas satisfying the plurality of target points from among the obtained plurality of processable areas.

### BACKGROUND OF THE INVENTION

1. Field of the Invention

The present invention relates to a moving body placement determining method, a measuring apparatus, a machining apparatus, and a storage medium.

2. Description of the Related Art

Measuring apparatuses or machining apparatuses should preferably have a total processing time required for measurement or machining as short as possible. Here, the measuring apparatuses are apparatuses that move a measurement tool relative to an object to be measured so as to perform a measurement operation for desired points (target points) set on the object to be measured using the measurement tool. Also, the machining apparatuses are apparatuses that move a machining tool relative to an object to be machined so as to perform a machining operation for desired points (target points) on the object to be machined using the machining tool. In this case, when the measurement tool or the machining tool is a moving body, a fewer number of times of movement of the moving body is advantageous for reducing a total processing time. Thus, there have been proposed techniques that determine the placements of a moving body minimally required for covering (encompassing) all points expected to be measured or all points expected to be machined. WO 2003/064107 discloses a machining planning method for simply dividing all the machining areas into rectangulars having a predetermined size in both X-axis direction and Y-axis direction along which beams scan at high speed. In the method, division numbers of rectangulars in both X-axis direction and Y-axis direction are compared to each other to thereby set a scanning direction having a smaller division number, divided areas, and the placement of the moving body as a measurement condition.

However, the effect of the method disclosed in WO 2003/064107 depends greatly on the machining area of an object to be machined, and thus, can only be expected for a simple surface area such as rectangular or square. The first reason for this is that the scanning direction of the moving body is limited in the method and the second reason for this is that a condition of a machining accuracy (accuracy relative to the moving body) is not taken into account in the method. Even when the method is applied to a machining area undulated in the horizontal direction, such as an S-shaped surface, the result in which the number of placements of the moving body is minimized is not necessarily obtained due to the first reason. Even when the method is applied to a machining area such as a concave surface, a machining accuracy cannot be ensured by the limitations of an angle of incidence and the depth of focus due to the second reason.

### SUMMARY OF THE INVENTION

The present invention provides, for example, a method for determining the placements of a moving body minimally required for covering target points set on an object while ensuring accuracy of processing by a moving body which performs a measurement operation or a machining operation.

According to an aspect of the present invention, a method for determining a placement of a moving body that moves to face an object and perform a process at a plurality of target points on the object, the method comprising the following steps executed by a processor: a step of setting candidates regarding the placement of the moving body for each of the plurality of target points; a step of obtaining a processable area, which is capable of being processed by the moving body in the object, corresponding to each of the set candidates; and a step of determining the candidate corresponding to a combination of the processable areas as the placement of the moving body by obtaining the combination of the processable areas satisfying the plurality of target points from among the obtained plurality of processable areas.

Further features of the present invention will become apparent from the following description of exemplary embodiments with reference to the attached drawings.

### BRIEF DESCRIPTION OF THE DRAWINGS

FIG. 1 is a flowchart illustrating a moving body placement determining method according to one embodiment.

FIG. 2 is a flowchart illustrating steps included in step S1.

FIG. 3 is a flowchart illustrating steps included in step S2.

FIG. 4 is a flowchart illustrating steps included in step S3.

FIG. 5 is a diagram illustrating a configuration of a measuring apparatus according to one embodiment.

FIG. 6 is a diagram illustrating information to be input as accuracy condition information in step S11.

FIG. 7 is a diagram illustrating a moving body placeable area.

FIG. 8 is a diagram illustrating moving body placement temporal candidates.

FIG. 9A is a diagram illustrating presence/absence of interference between each of moving body placement temporal candidates and a work.

FIG. 9B is a table illustrating the results of determination of presence/absence of interference with reference to FIG. 9A.

FIG. 10A is a diagram illustrating another example of determination in step S14 and settings in step S15.

FIG. 10B is a diagram illustrating still another example of determination in step S14 and settings in step S15.

FIG. 11 is a diagram illustrating accuracy condition parameters.

FIG. 12 is a diagram illustrating processable areas.

FIG. 13A is a diagram illustrating moving body placement candidates set in step S24.

FIG. 13B is a diagram illustrating the work corresponding to FIG. 13A as viewed from the Z-axis direction.

FIG. 14A is a diagram illustrating finally-obtained moving body placement and processable areas.

FIG. 14B is a diagram illustrating the work corresponding to FIG. 14A as viewed from the Z-axis direction.

### DESCRIPTION OF THE EMBODIMENTS

Hereinafter, preferred embodiments of the present invention will be described with reference to the drawings.

Firstly, a description will be given of a moving body placement determining method according to one embodiment of the present invention. The determining method may be employed for an industrial apparatus (hereinafter simply referred to as “apparatus”) such as a measuring apparatus or a machining apparatus. Firstly, an object (hereinafter referred to as “work”) such as an object to be measured or an object to be machined is present, and a plurality of points to be measured or a plurality of points to be machined (hereinafter referred to as “target points”) is set on the work. The apparatus moves a measurement tool or a machining tool (hereinafter referred to as “moving body”) relative to a work so as to perform measurement or machining (hereinafter referred to as “processing”). Note that the determining method may be executed, for example, as a program by a general purpose information processing device (computer) or may also be executed by an information processing device provided in an apparatus to be described below. Firstly, a description will be given of the overall flow of the moving body placement determining method according to the present embodiment. Next, a description will be given of a case where the method is specifically applied to an apparatus.

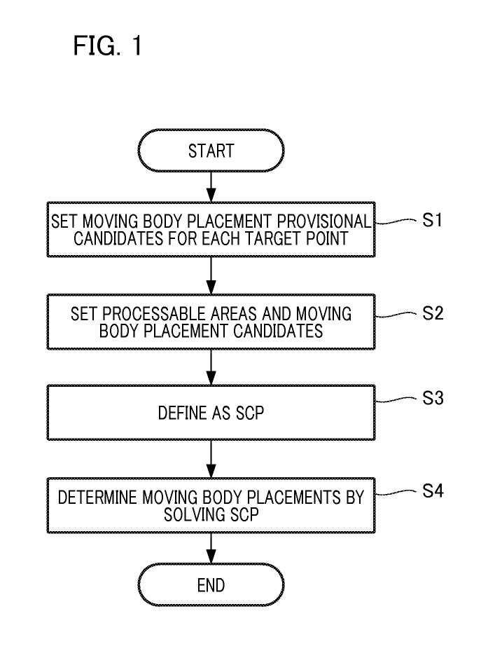

FIG. 1 is a flowchart illustrating the overall flow of processing until the placement of a moving body is determined according to the present embodiment. Moving body placement provisional candidates are set for each of the target points based on work information, moving body information, and accuracy condition information regarding processing by the moving body in step S1 (first step). Here, the term “moving body placement provisional candidate” refers to a provisional candidate for the placement of a moving body such that the moving body can process a target point set on a work with desired accuracy without interfering with the work. Next, a processable area and a moving body placement candidate are set for each of the moving body placement provisional candidates set in step S1 in step S2 (second step). Here, the term “processable area” refers to a set of target points on a work capable of being processed by a moving body with desired accuracy in a placement of the moving body. Also, the term “moving body placement candidate” refers to a candidate which corresponds to a processable area and may be the final placement of a moving body. Next, a set covering problem (hereinafter abbreviated as “SCP”) is defined by using the processable areas respectively set for the moving body placement candidates in step S2 in step S3 (third step). The SCP defined in step S3 is solved in step S4 (fourth step). In the present embodiment, a solution to the SCP is obtained as a result of step S4 so that a combination selected as the placements of the moving body where the cost is minimized from among the moving body placement candidates and processable areas corresponding thereto are obtained. Hereinafter, a specific description will be given of the content of steps S1 to S4.

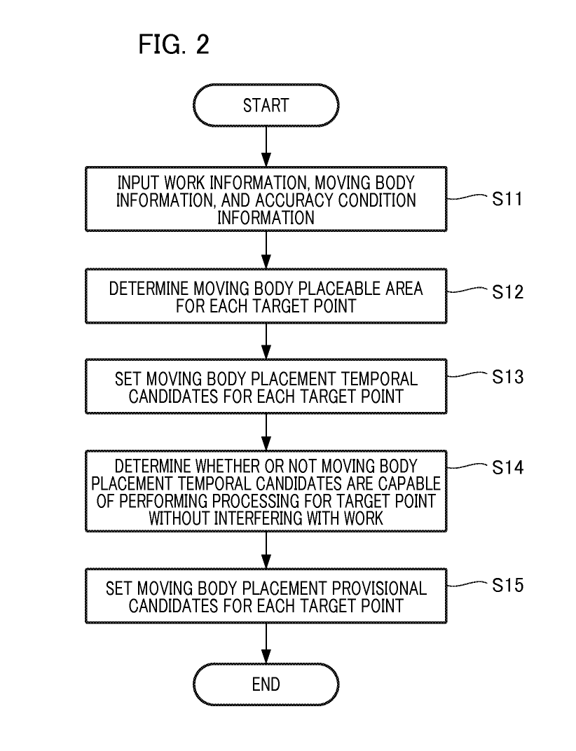

FIG. 2 is a flowchart illustrating steps included in step S1. Firstly, work information, moving body information, and accuracy condition information are input in step S11 (step 1A). Here, the term “work information” refers to information regarding the coordinates of target points, the shape of a work, and the placement of the work. The term “moving body information” refers to information regarding the shape of the moving body and information regarding the movable range of the moving body. Furthermore, the term “accuracy condition information” refers to information regarding conditions required for achieving desired accuracy upon processing by the moving body.

Next, a moving body placeable area is obtained for each of the target points with reference to work information and accuracy condition information in step S12 (step 1B). Here, the term “moving body placeable area” refers to an area in which the moving body is capable of performing processing for a target point with desired accuracy. Note that the moving body placeable area obtained herein also includes a placement at which the moving body cannot actually process the work because the area does not take into account conditions regarding interference between a work and a moving body.

Next, moving body placement temporal candidates are set for each of the target points in step S13 (step 1C). Here, the term “moving body placement temporal candidate” refers to a temporal candidate which is included in the moving body placeable area and may become a moving body placement candidate. At least one or more of the temporal candidates is set for one moving body placeable area. Although the number of moving body placement temporal candidates set for one moving body placeable area may be any, the number is preferably as many as possible from the viewpoints of the confidence of a finally obtained solution. Note that the number is variable depending on the load on computation processing performed until the moving body placement temporal candidates are set or the load on computation processing in step S14 and subsequent steps. Examples of a method for setting moving body placement temporal candidates include a method for setting moving body placement temporal candidates which are equidistantly spaced apart from one another on a three-dimensional space, a method for setting moving body placement temporal candidates which are equiangularly spaced apart from one another about the center of the target point, and the like. The method for setting moving body placement temporal candidates may vary with the shape of a work, the specification of a moving body, or the like.

Next, it is determined in step S14 (step 1D) whether or not the moving body placement temporal candidates set in step S13 are capable of performing processing for a target point without interfering with the work with reference to work information and moving body information. Here, the term “interference” refers to a phenomenon where light projected from a moving body is interrupted by a part of a work when the apparatus to which the moving body placement determining method according to the present embodiment is applied is, for example, a measuring apparatus that measures the distance between the moving body and the work by using noncontact probe as a moving body and projecting light from the moving body to the work. In contrast, the term “interference” refers to a phenomenon where, for example, the main body (portion which is not directly involved with machining) of a machining tool is brought into contact with a work when the apparatus to which the moving body placement determining method according to the present embodiment is applied is, for example, a machining apparatus including a machining tool which machines the surface of the work by being brought into abutment therewith as a moving body.

The moving body placements which have been determined in step S14 to be capable of performing processing without interfering with the work are set to the moving body placement provisional candidates for each of the target points in step S15 (step 1E). Note that the following is performed when only one moving body placement temporal candidate is set in step S13. Specifically, in this case, for the moving body placement temporal candidate which has been determined to interfere with the work, the moving body placement at which the moving body is capable of performing processing with highest accuracy under the condition in which no interference occurs with the work is set as a new moving body placement temporal candidate and is directly set as a moving body placement provisional candidate.

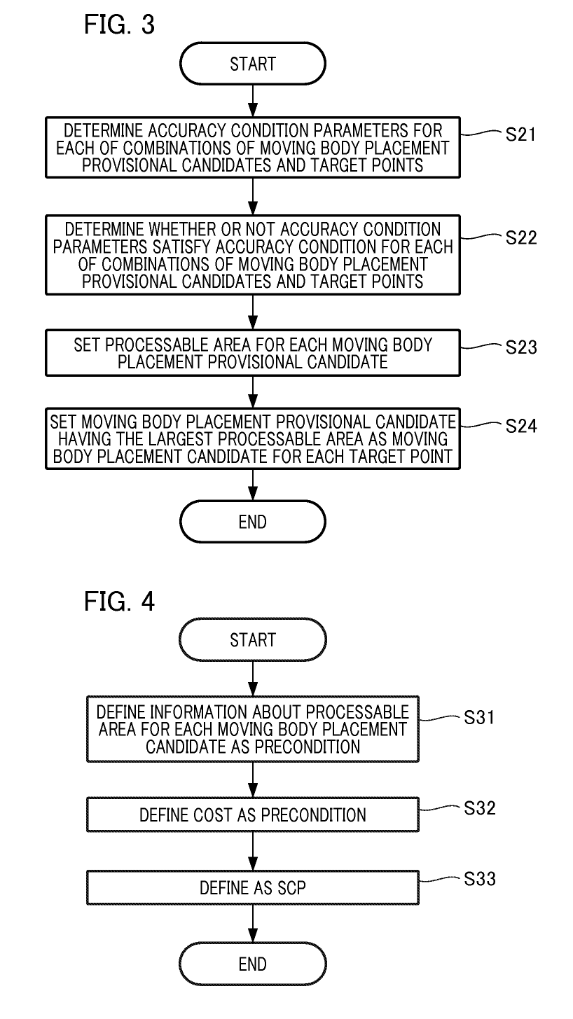

FIG. 3 is a flowchart illustrating steps included in step S2. Firstly, accuracy condition parameters are obtained for each of combinations of the moving body placement provisional candidates and the target points in step S21 (step 2A). Here, the term “accuracy condition parameter” refers to an item for determining whether or not the combination is capable of achieving the desired accuracy of the moving body with respect to the accuracy condition included in accuracy condition information.

Next, it is determined in step S22 (step 2B) whether or not the accuracy condition parameters obtained in step S21 satisfy the accuracy condition for each of the combinations of the moving body placement provisional candidates and the target points. Although it is preferable that determination is performed for all the combinations of the moving body placement provisional candidates and the target points, a part of the combinations may be omitted when there is a constraint on a calculation time. In addition, it is preferable that the determination criteria used herein is to simultaneously satisfy all the accuracy conditions, a part of the accuracy conditions may be ignored when there is a constraint on the number of moving body placement candidates.

Next, the target points which have been determined to satisfy the accuracy condition in step S22 are subject to grouping for each of moving body placement provisional candidates in step S23 (step 2C) and are set as a processable area.

The moving body placement provisional candidate having the largest processable area is set as a moving body placement for each of the target points in step S24 (step 2D). While a moving body placement provisional candidate is set for each of the target points in step S1, the sizes of the processable areas for moving body placement provisional candidates respectively corresponding to the target points are compared to each other. More specifically, the number of target points included in a processable area is compared with the number of target points included in other processable areas and then the moving body placement provisional candidate including the largest number of target points is set to a moving body placement candidate. Note that step S24 may be omitted depending on the number of moving body placement temporal candidates set in step S13. For example, when the number of moving body placement temporal candidates is one for each target point in step S13, only one moving body placement provisional candidate is set for each target point, and thus, there is no need to compare the size of the processable area in step S24.

FIG. 4 is a flowchart illustrating steps included in step S3. Firstly, information about the processable area for each moving body placement candidate obtained in step S2 is defined as a precondition in step S31 (step 3A).

Next, the cost of solving the SCP is defined as a precondition in step S32 (step 3B). In this case, the cost is the number of moving body placement candidates required for covering all the target points.

Next, the SCP is defined in step S33 (step 3C) so as to output a solution where the cost is minimized using the preconditions defined in steps S31 and S32. Here, database is created in accordance with the data format of a SCP solving unit. Note that an algorithm for SCP is not limited to a specific method but any algorithm may be used provided that it calculates a combination such that the number of placements of a moving body is minimized or sub-minimized. For example, a method for calculating an exact solution, such as Mixed Integer Programming or the like, may be used or a method for calculating a near-optimal solution, such as a moderating method or the like, may also be used. The SCP will be described in detail below.

Next, a detailed description will be given of step S4 together with the description of SCP. The SCP is a problem for selecting a combination of subsets such that the number of subsets required for covering all the elements of a set U is minimized when the set U and families of its subsets, i.e., S1, S2, . . . , and Sm are given. Note that a union of subsets S1, S2, . . . , and Sm is assumed to be equal to the set U. An algorithm used for solving SCP is Mixed Integer Programming. Mixed Integer Programming is an algorithm for calculating an exact solution to the given problem but may take a longer calculation time depending on a problem to be solved. Here, the term “exact solution” refers to a solution in which the cost is ensured to be minimized. Thus, as a method for reducing a calculation time, Mixed Integer Programming may be combined with a branch and bound method. In order to further reduce a calculation time, a moderating method for obtaining a near-optimal solution by moderating constraints may also be used. Here, the term “near-optimal solution” refers to a solution which is regarded as useful from the viewpoints of practical use because the cost is not ensured to be minimized but is sufficiently small as compared with other solutions. In particular, in the present embodiment, the placements of a moving body minimally required for covering all points expected to be measured or all points expected to be machined can be determined by solving the SCP using these methods.

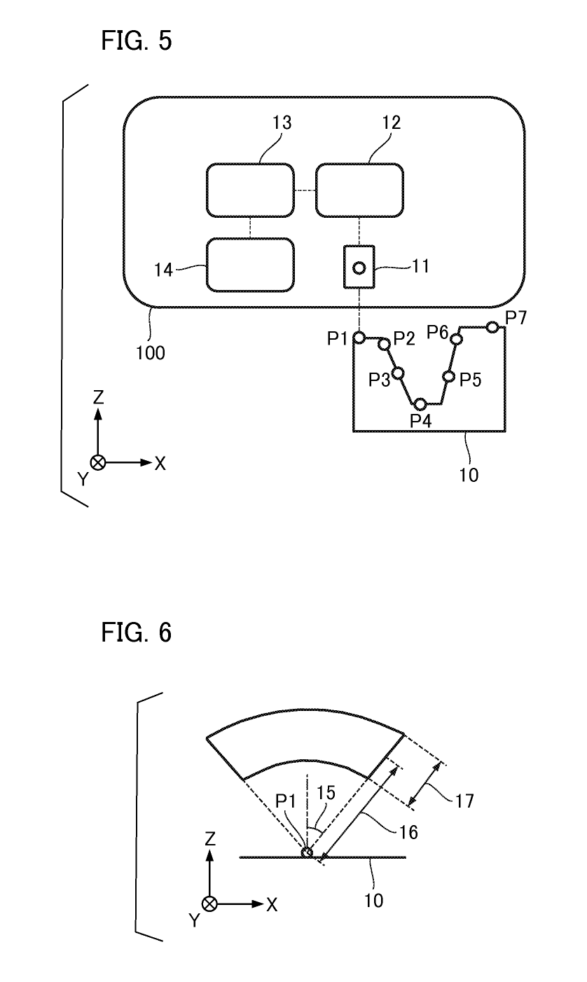

Next, a description will be given of the case where the aforementioned moving body placement determining method is specifically applied to an apparatus. Here, as an example, the moving body placement determining method according to the present embodiment is applied to a measuring apparatus that contactlessly measures the distance between a moving body and a work or the shape of the work by projecting light from the moving body to the work. FIG. 5 is a schematic diagram illustrating a configuration of a measuring apparatus 100 according to the present embodiment. In the following drawings, mutually orthogonal X- and Y-axes are aligned in a plane with a work 10 placed thereon and the Z-axis is aligned in a direction (in the present embodiment, vertical direction) perpendicular to the XY plane. Firstly, the cross section of the work 10 to be measured by the measuring apparatus 100 is formed in a concave shape, and a preset plurality of target points P (P1 to P7) is present on the surface to be measured (surface). The measuring apparatus 100 includes a moving body 11 that stands facing the work 10, a drive unit 12 that changes the placement of the moving body 11 by moving it, a control unit 13 that transmits a drive command to the drive unit 12, and a placement determining unit 14 that determines the placement of the moving body 11 during processing (in this case, during measuring). The moving body 11 is a measurement element (measuring probe) that is movable relative to the work 10 by the operation of the drive unit 12 and projects/receives light onto/from the target points P. Note that it is preferable that light from the moving body 11 is scanned by a scanning unit (not shown) (e.g., galvanometer mirror) provided within the moving body 11 at a high speed from the viewpoints of reduction in a processing time. The present invention is not necessarily limited thereto, but light may also be scanned by the movement of the moving body 11 by the operation of the drive unit 12 instead of provision of the scanning unit. When the measuring apparatus 100 has such a configuration, the placement determining unit 14 may execute the moving body placement determining method according to the present embodiment, for example, as a program. Here, while the moving body placement determining method according to the present embodiment is intended to be applied to a measuring apparatus including a non-contact probe as a moving body, the method may also be applied to a measuring apparatus including a contact probe or may further be applied to a machining apparatus including a contact or a non-contact machining tool.

Next, a detailed description will be given of the flow for determining the placement Q of the moving body 11 provided in the measuring apparatus 100 in accordance with steps from step S1 to step S4. Firstly, when processing is started in step S1, the coordinates of the target points P, the shape of the work 10, and the placement of the work 10 as shown in FIG. 5 are input as work information by input from the operator in step S11. Likewise, the range of movement of the moving body 11 in each drive axis is input as moving body information. Furthermore, in this case, information about an angle of incidence to any target point set on the moving body 11, a focal distance, and the depth of focus is input as accuracy condition information. FIG. 6 is a schematic diagram illustrating information to be input as accuracy condition information. As an example, an angle of incidence 15 to the target point P1 set on the moving body 11, a focal distance 16, and the depth of focus 17 are shown in FIG. 6.

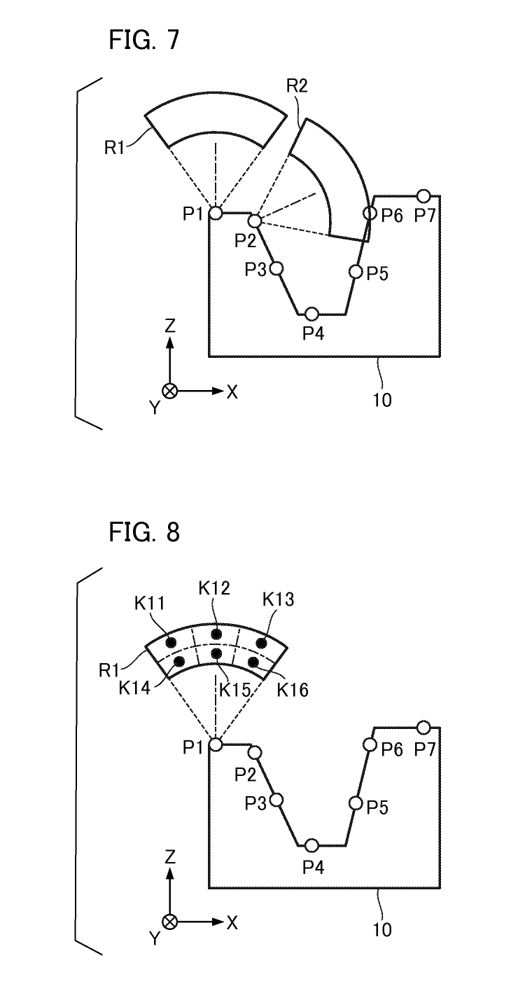

Next, a moving body placeable area R (R1 to R7) is obtained for each of the target points P in step S12. FIG. 7 is a schematic diagram illustrating the moving body placeable area R. As an example, the moving body placeable areas R1 and R2 respectively for the target points P1 and P2 are shown in FIG. 7. Although not illustrated, the moving body placeable areas R3 to R7 respectively for other target points P3 to P7 are also obtained.

Next, the moving body placement temporal candidates K (K11 to K16) are set for each of the target points P in step S13. FIG. 8 is a schematic diagram illustrating the moving body placement temporal candidates K. As an example, the moving body placement temporal candidates K set for the moving body placeable area R1 are shown in FIG. 8. Although not illustrated, the moving body placement temporal candidates K are also set for each of other target points P2 to P7. The number of the moving body placement temporal candidates K may also be one for each target point P. In this case, it is preferable that the moving body placement temporal candidates K to be set are placed at positions corresponding to a focal distance (the focal distance 16 in FIG. 6) along a direction normal to each target point P.

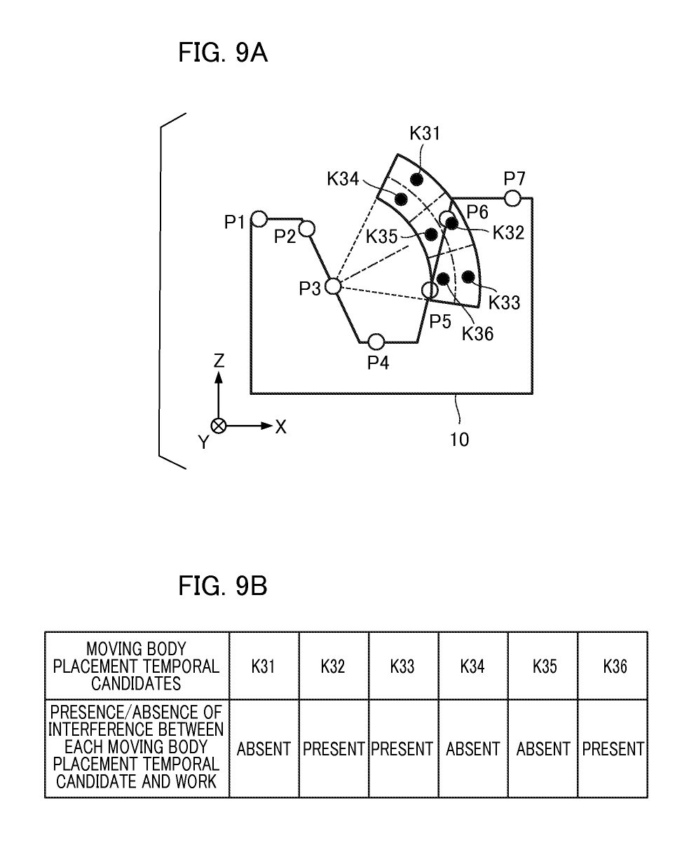

Next, it is determined in step S14 whether or not the moving body placement temporal candidates K are capable of performing measurement for the target point P without interfering with the work 10. FIG. 9 is a diagram illustrating interference between the moving body placement temporal candidates K and the work 10. In particular, FIG. 9A is a schematic diagram illustrating presence/absence of interference between each of the moving body placement temporal candidates K31 to K36 set for the target point P3 and the work 10 as an example. On the other hand, FIG. 9B is a table illustrating the results of determination of presence/absence of interference with reference to FIG. 9A. In the case shown in FIG. 9, it is determined that no interference occurs between each of three moving body placement temporal candidates K31, K34, and K35 and the work 10, whereas it is determined that interference occurs between each of other moving body placement temporal candidates K32, K33, and K36 and the work 10. Although not shown in FIG. 9, a similar determination is also made for the moving body placement temporal candidates K corresponding to each of other target points P1 and P2 to P7.

The moving body placement temporal candidates K (in the example shown in FIG. 9, K31, K34, and K35) which have been determined not to be in contact with the work 10 are set as the moving body placement provisional candidates M based on the results of determination obtained in step S14 in step S15.

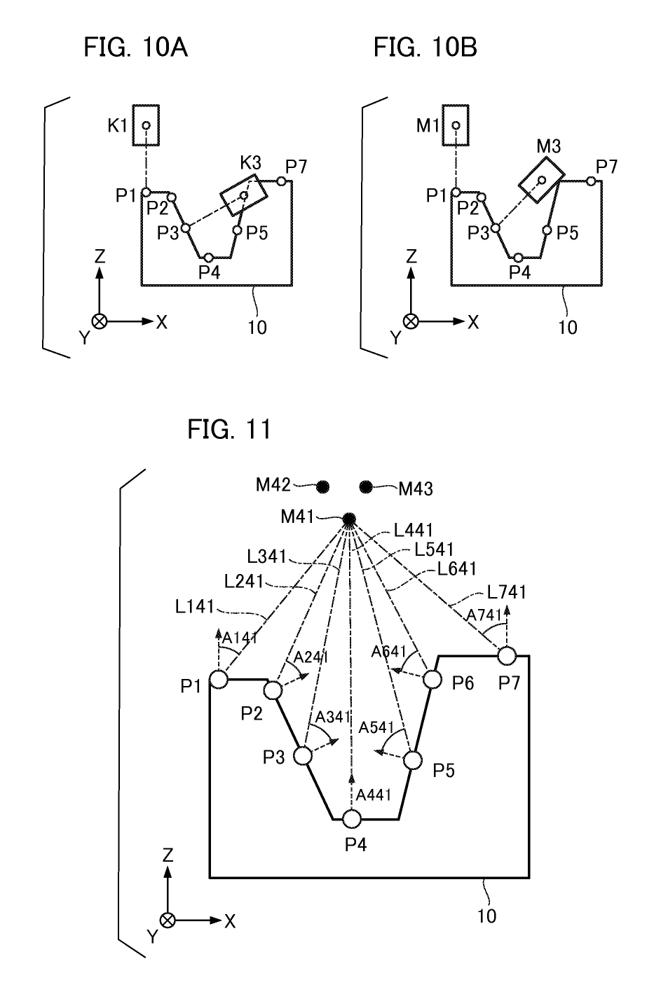

Here, a description will be given of determination in step S14 and settings in step S15 when only one moving body placement temporal candidate K is set for each target point P in step S13. FIG. 10 is a schematic diagram illustrating determination in step S14 and settings in step S15 in this case. In particular, FIG. 10A shows an example in which determination in step S14 is made for two target points P1 and P3. On the other hand, FIG. 10B shows an example in which settings in step S15 are made for two target points P1 and P3. Firstly, the moving body placement temporal candidate K1 is set for the target point P1 and the moving body placement temporal candidate K3 is set for the target point P3 as shown in FIG. 10A. At this time, it is determined in step S14 that no interference occurs between the moving body placement temporal candidate K1 and the work 10 and interference occurs between the moving body placement temporal candidate K3 and the work 10. Next, the moving body placement provisional candidates M are set in step S15 as shown in FIG. 10B. Specifically, the moving body placement temporal candidate K1 which has been determined in step S14 that no interference occurs between the moving body placement temporal candidate K1 and the work 10 is directly set as the moving body placement provisional candidate M1 as it is. On the other hand, for the moving body placement temporal candidate K3 which has been determined in step S14 that interference occurs between the moving body placement temporal candidate K3 and the work 10, a moving body placement temporal candidate K3′ which is capable of performing measurement (processing) for the target point P3 with highest accuracy without interfering with the work 10 is newly obtained and is set as the moving body placement provisional candidate M3.

Next, the process shifts to step S2. Firstly, accuracy condition parameters are obtained for each of combinations of the moving body placement provisional candidates M and the target points in step S21. FIG. 11 is a schematic diagram illustrating an example of accuracy condition parameters for each of combinations of the moving body placement provisional candidate M41, from among the moving body placement provisional candidates M41, M42, and M43 set for the target point P4 as a result of step S1, and the target points P1 to P7. Here, since a description is given of the measuring apparatus 100 including the moving body 11 which projects/receives light onto/from the target points P, information about angles of incidence A141 to A741, respectively, from the moving body placement provisional candidate M41 to the target points P1 to P7 and information about the optical path length of each of incident light L141 to L741 may be used as accuracy condition parameters. Although not illustrated, information about an angle of incidence to each of the target points P1 to P7 and information about the optical path length of each incident light are likewise used as accuracy condition parameters for other moving body placement provisional candidates M42 and M43. Accuracy condition parameters are obtained not only for the moving body placement provisional candidates M set for the target point P4 but also for the moving body placement provisional candidates M set for each of other target points P1 to P3 and P5 to P7 similarly.

Next, accuracy condition parameters obtained in step S21, which are an angle of incidence and the optical path length of incident light, are compared with accuracy condition information which is information about the maximum angle of incidence of the moving body 11, a focal distance, and the depth of focus in step S22. Then, it is determined whether or not the condition of an angle of incidence and the condition of the optical path length simultaneously satisfy accuracy conditions.

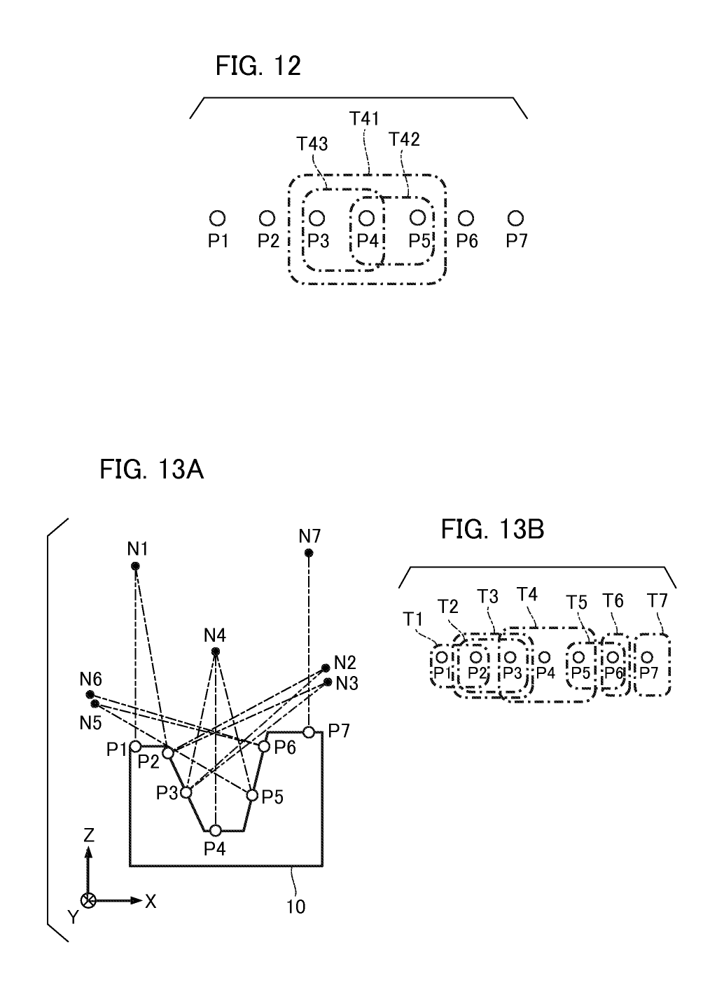

Next, an area capable of being processed by the moving body 11 is set for each moving body placement provisional candidate M based on the results of determination in step S22 in step S23. FIG. 12 is a plan view illustrating the processable area T which may be set for each of the moving body placement provisional candidates M41, M42, and M43 for the target points P1 to P7 as viewed from the Z-axis direction of the work 10. In this case, the target points P3, P4, and P5 are included in a processable area T41 set for the moving body placement provisional candidate M41. Likewise, the target points P3 and P4 are included in a processable area T42 set for the moving body placement provisional candidate M42, and the target points P4 and P5 are included in a processable area T43 set for the moving body placement provisional candidate M43.

Next, the sizes of the processable areas T set for the moving body placement provisional candidates Q respectively for the target points P are compared to each other in step S24. In the example shown in FIG. 12, the largest number of target points P is included in the processable area T41, and thus, the moving body placement provisional candidate M41 corresponding to the processable area T41 is set as the moving body placement candidate N. Likewise, such settings are made for all the moving body placement provisional candidates M set in step S1. FIG. 13 is a schematic diagram illustrating the moving body placement candidates N set in step S24. In particular, FIG. 13A is a diagram illustrating a correspondence between each of the set moving body placement candidates N1 to N7 and the target points P1 to P7 at which the accuracy condition is satisfied with respect to each of the moving body placement candidates N1 to N7 with a chain-dotted line. In this case, for example, the moving body placement candidate N1 satisfies the accuracy condition for the target points P1 and the target points P2. FIG. 13B is a plan view illustrating the work 10 corresponding to FIG. 13A as viewed from the Z-axis direction. As shown in FIG. 13B, the processable areas T1 to T7 are mutually overlapped.

Next, the process shifts to step S3 and the processable areas T respectively set for the moving body placement candidates N in step S2 are defined as an SCP as described above. The SCP defined in step S3 is solved in step S4. By performing a series of steps from step S1 to step S4, a combination of the moving body placements Q selected as the placements where the cost is minimized from among the moving body placement candidates N and the processable areas T corresponding thereto can be finally obtained.

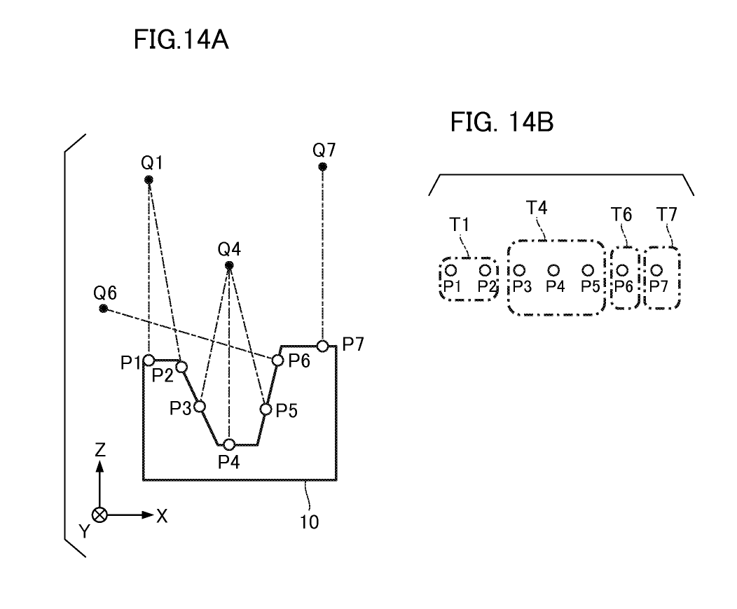

FIG. 14 is a diagram illustrating examples of the moving body placements Q and the processable areas T which are finally obtained by the moving body placement determining method according to the present embodiment. In particular, FIG. 14A is a schematic diagram illustrating a correspondence between each of the moving body placements Q1, Q4, Q6, and Q7 obtained by solving the SCP and the target points P1 to P7 corresponding thereto with a chain-dotted line. The moving body placements Q1, Q4, Q6, and Q7 are determined in this way, so that the target points P1 to P7 can be covered with the minimum number of placements of the moving body 11. FIG. 14B is a diagram illustrating the work 10 corresponding to FIG. 14A as viewed from the Z-axis direction. As shown in FIG. 14B, a union of the processable areas T1, T4, T6, and T7 covers all the target points P1 to P7.

As described above, according to the present embodiment, a method for determining the placements of a moving body minimally required for covering all the target points set on an object while ensuring accuracy of processing by the moving body may be provided. Consequently, an apparatus that employs the moving body placement determining method can reduce a total processing time while ensuring accuracy of processing.

While, in the present embodiment, a description has been given of the case where the placement of the moving body is determined by solving a set covering problem, the present invention is not limited thereto. The candidate corresponding to a combination of processable areas may also be determined as the placement of the moving body by obtaining the combination of the processable areas satisfying a plurality of target points set on an object from among a plurality of processable areas.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-101283 filed on May 13, 2013, which is hereby incorporated by reference herein in its entirety.

1. A method for determining a placement of a moving body that moves to face an object and performs a process at a plurality of target points on the object, the method comprising the following steps executed by a processor:
a step of setting candidates regarding the placement of the moving body for each of the plurality of target points;
a step of obtaining a processable area, which is capable of being processed by the moving body in the object, corresponding to each of the set candidates; and
a step of determining the candidate corresponding to a combination of the processable areas as the placement of the moving body by obtaining the combination of the processable areas satisfying the plurality of target points from among the obtained plurality of processable areas.

2. The determining method according to claim 1, wherein a combination of the minimum number of the processable areas satisfying the plurality of target points is obtained from among the obtained plurality of processable areas.

3. The determining method according to claim 1, wherein the placement of the moving body is determined in the determining step by solving a set covering problem using the obtained plurality of processable areas.

4. The determining method according to claim 1, wherein the step of setting the candidates further comprises:
a first step of setting a plurality of provisional candidates regarding the placement of the moving body for each of the target points,
a second step of determining candidates regarding the placement of the moving body for each of the target points from the plurality of provisional candidates set in the first step based on the processable areas capable of being processed by the moving body in the object,
a third step of defining a set covering problem using the processable area, which is capable of being processed by the moving body in the object, set for each of the candidates determined in the second step, and
a fourth step of determining the placement of the moving body by solving the set covering problem defined in the third step.

5. The determining method according to claim 4, wherein the first step further comprises:
a step 1A of inputting information regarding the object, information regarding the moving body, and information regarding the accuracy condition of the processing;
a step 1B of determining an area in which the placement of the moving body is expected for each of the target points with reference to the information input in the step 1A;
a step 1C of setting a temporal candidate regarding the placement of the moving body, which is included in the area in which the placement of the moving body is expected determined in the step 1B, for each of the target points;
a step 1D of determining whether or not the temporal candidate is capable of performing processing for the target point corresponding to the temporal candidate set in the step 1C without interfering with the object; and
a step 1E of setting the provisional candidate from the temporal candidate, which has been determined in step 1D that the temporal candidate does not interfere with the object, for each of the target points.

6. The determining method according to claim 5, wherein the information regarding the object includes information about the coordinates of the target points, the shape of the object, and the placement of the object.

7. The determining method according to claim 5, wherein the information regarding the moving body includes information about the shape of the moving body and the movable range of the moving body.

8. The determining method according to claim 5, wherein at least one or more of the temporal candidates is set within an area in which the placement of the moving body is expected in the step 1C.

9. The determining method according to claim 5, wherein, when it is determined that the temporal candidate interferes with the object at a specific target point, the temporal candidate which does not interfere with the object is newly determined and the newly determined temporal candidate is set to the provisional candidate in the step 1E.

10. The determining method according to claim 4, wherein the second step further comprises:
a step 2A of determining accuracy condition parameters for each of combinations of the provisional candidates and the target points;
a step 2B of determining whether or not the accuracy condition parameters determined in the step 2A satisfies the accuracy condition for each of the combinations of the provisional candidates and the target points;
a step 2C of setting a set of target points which have been determined to satisfy the accuracy condition in the step 2B as the processable area for each of the provisional candidates; and
a step 2D of setting the provisional candidate having the largest area, which is capable of being processed by the moving body, set in the step 2C as a candidate regarding the placement of the moving body for each of the target points.

11. The determining method according to claim 10, wherein the accuracy condition parameter is an item for determining whether or not the combination is capable of achieving the desired accuracy of the moving body with respect to the accuracy condition.

12. The determining method according to claim 10, wherein the provisional candidate having the largest number of the target points included in the processable area is set as the candidate in the step 2D.

13. The determining method according to claim 4, wherein the third step further comprises:
a step 3A of defining the processable areas respectively for the candidates as a precondition of a set covering problem;
a step 3B of defining a cost as the precondition of the set covering problem; and
a step 3C of defining the set covering problem so as to determine a solution when the cost defined in the step 3B is minimized.

14. The determining method according to claim 13, wherein the cost is the number of the candidates required for covering all the target points.

15. The determining method according to claim 1, wherein the processing includes measuring or machining.

16. A measuring apparatus that measures an object, wherein a placement of a moving body that moves to face an object and measures a plurality of target points set on the object is determined by a determining method for determining a placement of a moving body that moves to face an object and perform a process at a plurality of target points on the object, the method comprising the following steps executed by a processor:
a step of setting candidates regarding the placement of the moving body for each of the plurality of target points;
a step of obtaining a processable area, which is capable of being processed by the moving body in the object, corresponding to each of the set candidates; and
a step of determining the candidate corresponding to a combination of the processable areas as the placement of the moving body by obtaining the combination of the processable areas satisfying the plurality of target points from among the obtained plurality of processable areas.

17. A machining apparatus that machines an object, wherein a placement of a moving body that moves to face an object and machines a plurality of target points set on the object is determined by a determining method for determining a placement of a moving body that moves to face an object and perform a process at a plurality of target points on the object, the method comprising the following steps executed by a processor:
a step of setting candidates regarding the placement of the moving body for each of the plurality of target points;
a step of obtaining a processable area, which is capable of being processed by the moving body in the object, corresponding to each of the set candidates; and
a step of determining the candidate corresponding to a combination of the processable areas as the placement of the moving body by obtaining the combination of the processable areas satisfying the plurality of target points from among the obtained plurality of processable areas.

18. A non-transitory storage medium on which is stored a computer program for making an information processor execute a method for determining a placement of a moving body that moves to face an object and perform a process at a plurality of target points on the object, the method comprising the following steps executed by a processor:
a step of setting candidates regarding the placement of the moving body for each of the plurality of target points;
a step of obtaining a processable area, which is capable of being processed by the moving body in the object, corresponding to each of the set candidates; and
a step of determining the candidate corresponding to a combination of the processable areas as the placement of the moving body by obtaining the combination of the processable areas satisfying the plurality of target points from among the obtained plurality of processable areas.
